(19) United States
(12) Patent Application Publication
(10) Pub. No.: US 2012/0274428 A1
(43) Pub. Date: Nov. 1, 2012

(54) CIRCUIT-BREAKER WITH A COMMON HOUSING

(75) Inventors: Christian REUBER, Willich (DE); Dietmar Gentsch, Ratingen (DE); Philipp Masmeier, Dusseldorf (DE)

(73) Assignee: ABB Technology AG, Zurich (CH)

(21) Appl. No.: 13/447,910

(22) Filed: Apr. 16, 2012

Related U.S. Application Data
(63) Continuation of application No. PCT/EP2010/006288, filed on Oct. 14, 2010.

(30) Foreign Application Priority Data
Oct. 14, 2009 (EP) 09012967.7

(51) Int. Cl. H01H 77/06

(52) U.S. Cl. 335/6

(57) ABSTRACT

A circuit-breaker is provided for switching medium-voltage to high-voltage circuits. The circuit breaker includes a pole part having a cup-shaped housing made of insulating material for accommodating an interrupter insert operated by a drive rod. The cup-shaped housing is divided into an upper housing part in which the interrupter insert is arranged, and a lower housing part for accommodating a magnetic actuator. The drive rod of the interrupter insert is coaxially arranged to an armature of the magnetic actuator.

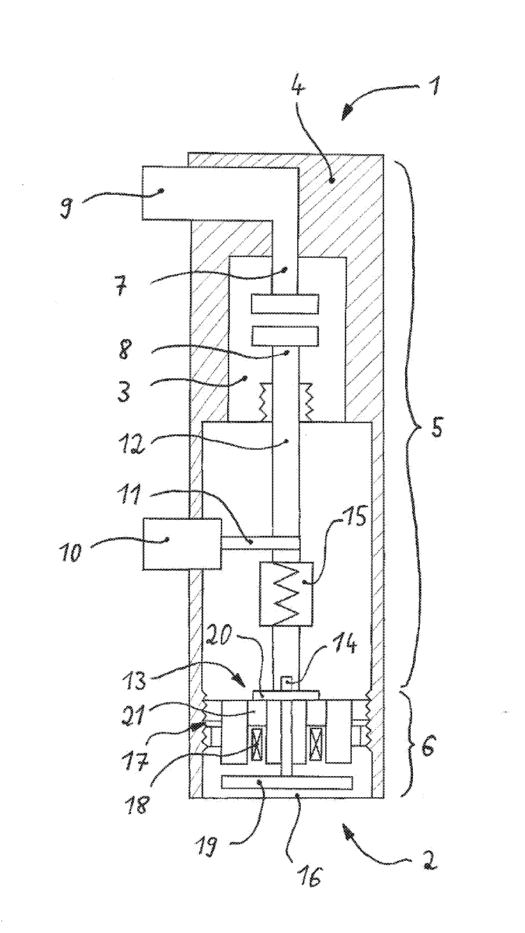

### RELATED APPLICATION(S)

This application claims priority as a continuation application under 35 U.S.C. §120 to PCT/2010/006288, which was filed as an International Application on Oct. 14, 2010 designating the U.S., and which claims priority to European Application 09012967.7.5 filed in Europe on Oct. 14, 2009. The entire contents of these applications are hereby incorporated by reference in their entireties.

### FIELD

The present disclosure relates to a pole part of a circuit-breaker for switching medium-voltage to high-voltage circuits, in which the pole part includes a cup-shaped housing made of insulating material for accommodating an interrupter insert operated by a drive rod. Furthermore, the present disclosure relates to a circuit-breaker which is actuated by a bistable electromagnetic actuator and includes such a pole part.

The present disclosure is also focused on the field of medium voltage vacuum circuit breakers. These special circuit breakers improve the interruption process substantially through reduced contact travel, reduced contact velocity and small masses for moving the electrical contacts. Accordingly, these vacuum circuit breakers require a significantly smaller, lower energy actuator which is usually designed as an electromagnetic device having at least one electrical coil surrounded by ferromagnetic joke assembly which corresponds with a moveable ferromagnetic armature in order to generate a suitable mechanical actuating force for the interrupter insert of all connected pole parts. Generally, three pole parts are utilized for a medium voltage circuit breaker of a power grid.

A medium voltage circuit breaker rated between 1 and 72 kV is mostly assembled into a metal-enclosed switch gear line-up for indoor use, or may be installed outdoor in a substation. Nowadays, modern vacuum circuit breakers replace air-brake circuit breakers for indoor applications. The characteristics of medium-voltage breakers are given by international standards. Especially, vacuum circuit breakers rate current up to 300 Ampere.

These breakers interrupt the current by creating and extinguishing the arc in a vacuum container. Nevertheless, the present disclosure is not only applicable to vacuum circuit breakers, but also to air circuit breakers or modern SF₆ circuit breakers having a chamber filled with sulfurhexafluoride gas. The present disclosure may also be applicable to high-voltage circuit breakers.

### BACKGROUND INFORMATION

It is known that circuit breakers of the kind as mentioned above are mostly equipped with electromagnetic actuators. An electromagnetic actuator generally generates a high force density to fast operate the moving contacts of the interrupter inserts. A permanent magnetic arrangement is used for providing a sufficient static holding force for keeping the electrical contacts in the opened or in the closed position. An integrated electrical coil is feed with electrical energy for bringing the actuator from the closed to open position. Usually, an electromagnetic actuator is accommodated in its own housing.

EP 0 898 780 B1 describes an electromagnetically actuated medium-voltage circuit breaker. A single electromagnetic actuator drives a common jackshaft. The jackshaft internally couples the actuator force to the moving electrically contacts of each vacuum interrupter on all three pole parts through insulated push rods. The electromagnetic actuator consists of a bistable magnet system, in which switching the armature to the relative positions—open or closed—is effected by the magnetic field of an electrically excited coil. The magnetic latching requires holding means for the contacts during faults. A permanent magnet arrangement holds the ferromagnetic armature in one of the two positions. In the open position, the electrical contacts of the vacuum interrupter are opened; in the closed position, these electrical contacts are closed.

All main parts of the circuit breaker need their own housing, especially, the three pole parts include a secure insulating housing. Also, the operating mechanism and the actuator part are equipped with respective housings which are shaped according to the technical functions of these parts.

All these housings have to assemble one to another by means of screws during the manufacturing process of the circuit breaker. This construction principle causes big geometrical dimensions of the circuit breaker device.

Furthermore, the known separate housing solution to realize a mechanical connection between the at least one actuator and the driven pole parts as well as the operating mechanism results in loss of operating stroke due to the looseness and flexibility of all parts. Additionally, it increases the manufacturing effort of the circuit breaker, both for material and for assembly.

DE 102 38 950 A1 discloses another solution which solves the aforementioned problem by using another arrangement principle of the main parts. According to this arrangement principle, the actuator part is coaxially arranged to the pole part of the circuit breaker. The pole part consists of a housing of plastic material for containing a vacuum interrupter insert. In contrast to that electrically insulated housing, the actuator part is housed in a ferromagnetic joke arrangement which surrounds two electrical coils as well as an intermediate permanent magnet for generating the mechanical force of the magnetic actuator. The ferromagnetic joke arrangement is necessary in order to lead the magnetic flux which creates the mechanical force in conjunction with the adjacent moveable armature.

The moveable armature consists of a divided axis rod having a plunger section on each side. One part of the divided axis rod is connected to a drive rod of the interrupter insert. The drive rod moves the lower electrical contact of the pair of electrical contacts of the interrupter insert. The upper electrical contact is generally fixed, but electrically supported. Between the housing of the pole part and the housing of the magnetic actuator, an additional metal plate for grounding purposes is arranged.

The circuit breaker as described above has a compact design, but each main part is provided with its own housing. Especially, the metallic housing of the magnetic actuator assembly which is represented by ferromagnetic joke is exposed. Under security aspects, exposed electrical parts are dangerous.

### SUMMARY

An exemplary embodiment of the present disclosure provides a pole part of a circuit-breaker for switching medium-voltage to high-voltage circuits. The exemplary pole part includes a cup-shaped housing made of insulating material for accommodating an interrupter insert operated by a drive rod. The cup-shaped housing is divided into an upper housing part in which the interrupter insert is arranged, and a lower housing part for accommodating a magnetic actuator. The drive rod of the interrupter insert is coaxially arranged to an armature of the magnetic actuator.

### BRIEF DESCRIPTION OF THE DRAWING

The drawing shows a schematic side view of a medium-voltage circuit-breaker actuated by a bistable electromagnetic actuator for operating a corresponding pole part, according to an exemplary embodiment of the present disclosure.

### DETAILED DESCRIPTION

Exemplary embodiments of the present disclosure provide a compact designed circuit-breaker having a secure insulated housing arrangement.

According to an exemplary embodiment of the present disclosure, a medium-voltage to high-voltage circuit-breaker includes a special pole part with a cup-shaped housing made of insulating material for accommodating an interrupter insert operated by a drive rod. The cup-shaped housing is divided into an upper housing part in which the interrupter insert is arranged, and a lower housing part for accommodating a magnetic actuator. The drive rod of the interrupter insert is coaxially arranged to the armature of the magnetic actuator.

In other words, the present disclosure provides a special integration of the magnetic actuator into the pole part. The interrupter insert as well as the magnetic actuator and all remaining force transmission parts are inside a common housing made of insulating material. Hence, there is no need for separate housings. Due to the compact design, the number of parts is strongly reduced and the assembling time is significantly shorter.

In accordance with an exemplary embodiment, the axis rod of the magnetic armature is an integral part of the device rod of the interrupter insert to achieve a direct and compact connection. According to an exemplary embodiment, the axis rod is directly casted into the lower end of an insulating material of the drive rod. Alternatively, the axis rod could also screwed in the drive rod to attach the armature adjustable relative to the interrupter insert. The screw connection between the axis rod and the armature and the drive rod of the interrupter insert can be secured by locking means in order to avoid loosening during the life time. This thread locking can be reached by several ways, for example, by using a lock screw on the same thread. Alternatively, one or more small crews could be used at predefined locations into the thread. Furthermore, gluing of the thread for permanent locking is possible. This could be realized just by adding glue of ultrasonic welding from outside of the connected parts. The thread connection could be also designed in a way that the internal friction is sufficient to hold the actuator in place so that separate locking means are not required.

According to an exemplary embodiment of the present disclosure, the magnetic actuator is placed directly below the interrupter insert in the opening area of the cup shaped housing. Therefore, there is no need for additional mechanical linkage. In accordance with an exemplary embodiment, the magnetic actuator is provided with an outside screw thread which corresponds to an inside screw thread on the opening area of the cup-shaped housing. When the axis rod of the armature of the magnetic actuator is added during the assembly process, it can be screwed into the corresponding drive rod of the interrupter insert until the correct position relative to the interrupter insert is reached.

In accordance with an exemplary embodiment, the electromagnetic actuator includes one electrical coil for moving the ferromagnetic armature including a lower plunger and an upper plunger connected with the intermediate axis rod. After assembling of the axis rod by screwing into the corresponding drive rod of the vacuum interrupter, the upper plunger of the armature can be screwed onto the common axis; then the axis rod is added and finally the lower plunger in order to ensure an easy assembling procedure.

The foregoing and other aspects of the present disclosure will become apparent following the detailed description of the disclosure when considered in conjunction with the appended drawing.

The medium-voltage circuit breaker as shown in the drawing principally includes a pole part 1 and an electromagnetic actuator 2 which are coaxially arranged one to another.

For accommodating the electromagnetic actuator 2 as well as a vacuum interrupter insert 3, a common cup-shaped housing 4 is provided. The cup-shaped housing 4 is divided into an upper housing part 5 and a lower housing part 6. The upper housing part 5 contains the vacuum interrupter insert 3 and its operating means. In contrast, the lower housing part 6 contains the electromagnetic actuator 2. The cup-shaped housing 4 is composed of a suitable injection molded thermoplastic material.

The interrupter insert 3 is designed as a vacuum interrupter insert with a vacuum chamber in which a fixed electrical contact 7 and a corresponding moveable electrical contact 8 is arranged. Both electrical contacts 7 and 8 are coaxially arranged on opposite sides of the vacuum chamber. The fixed electrical contact 7 is connected to a corresponding electrical terminal 9 made of copper material molded in the housing 1.

The corresponding electrical contact 8 of the vacuum interrupter insert 3 is moveably connected to a corresponding electrical terminal 10 which is also molded in the housing 1. An intermediate flexible connector 11 is arranged between the electrical terminal 10 and the moveable electrical contact 8.

The vacuum interrupter insert 3 is operated by a drive rod 12 made of insulating material which is coaxially connected to the armature 13 of the magnetic actuator 2. An axis rod 14 of the armature 13 is casted into the lower end of the insulating material of the drive rod 12. In the force flow between the armature 13 of the magnetic actuator 2 and the drive rod 12 of the vacuum interrupter insert 3, a wipe spring arrangement 15 is integrated.

The magnetic actuator 2 integrated in the lower housing part 6 of the pole port 1 is placed directly below the interrupter insert 3 in an opening area 16 of the cup-shaped housing 4. In order to attach the magnetic actuator 2 in the opening area 16 of the housing 4, an outside screw thread 17 is provided thereon which corresponds to an inside screw thread molded in the opening area 16 of the housing 4. The screw connection between the magnetic actuator 2 and the housing 4 is secured by fixing means.

The electromagnetic actuator 2 includes one electrical coil 18 for moving the ferromagnetic armature 13. The ferromagnetic armature 13 includes a lower plunger 19 and an upper plunger 20 which are connected with the axis rod 14 in order to provide a constant distance between the lower plunger 19 and the upper plunger 20. The lower plunger 19 is visible from outside in order to indicate the current position of the armature 13 which corresponds with the switching position of the circuit breaker.

In order to hold the armature 13 in the ON position or the OFF position without electrical energy, an additional permanent magnet 21 is arranged adjacent to the electrical coil 18 of the electromagnetic actuator 2. The electromagnetic actuator 2 provides a bistable switching position for the mechanically connected vacuum interrupter insert 3.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE LIST

1 pole part
2 electromagnetic actuator
3 interrupter insert
4 housing
5 upper housing part
6 lower housing part
7 fixed electrical contact
8 moveable electrical contact
9 electrical terminal
10 electrical terminal
11 flexible connector
12 drive rod
13 armature
14 axis rod
15 wipe spring arrangement
16 opening area
17 screw thread
18 electrical coil
19 lower plunger
20 upper plunger
21 permanent magnet

What is claimed is:

1. A pole part of a circuit-breaker for switching medium-voltage to high-voltage circuits, the pole part comprising:
a cup-shaped housing made of insulating material for accommodating an interrupter insert operated by a drive rod,
wherein the cup-shaped housing is divided into an upper housing part in which the interrupter insert is arranged, and a lower housing part for accommodating a magnetic actuator, and
wherein the drive rod of the interrupter insert is coaxially arranged to an armature of the magnetic actuator.

2. The pole part according to claim 1,
wherein an axis rod of the magnetic armature is an integral part of the drive rod of the interrupter insert.

3. The pole part according to claim 2,
wherein the axis rod is casted into a lower end of an insulating material of the drive rod.

4. The pole part according to claim 1,
wherein the axis rod is screwed in the drive rod to attach the armature adjustable relative to the interrupter insert.

5. The pole part according to claim 4,
wherein a screw connection formed by the screw between the axis rod of the armature and the drive rod of the interrupter insert is secured by locking means.

6. The pole part according to claim 1,
wherein the magnetic actuator is placed directly below the interrupter insert in an opening area of the cup-shaped housing.

7. The pole part according to claim 6,
wherein the magnetic actuator includes an outside screw thread which corresponds to an inside screw thread in an opening area of the cup-shaped housing.

8. The pole part according to claim 1,
wherein the interrupter insert is designed as a vacuum interrupter insert with a fixed electrical contact and a corresponding movable electrical contact operated by the drive rod.

9. The pole part according to claim 1,
wherein the insulating material of the cup-shaped housing is injection molded plastic material.

10. The pole part according to claim 1,
wherein the electromagnetic actuator includes one electrical coil for moving the ferromagnetic armature including a lower plunger and an upper plunger connected with the intermediate axis rod.

11. A circuit-breaker for medium-voltage applications actuated by a bistable electromagnetic actuator for operating a pole part according to claim 1.

12. The circuit-breaker according to claim 11,
wherein three pole parts are combined in order to form a 3-phase device.

13. A circuit-breaker for medium-voltage applications actuated by a bistable electromagnetic actuator for operating a pole part according to claim 3.

14. A circuit-breaker for medium-voltage applications actuated by a bistable electromagnetic actuator for operating a pole part according to claim 5.

15. A circuit-breaker for medium-voltage applications actuated by a bistable electromagnetic actuator for operating a pole part according to claim 7.

16. A circuit-breaker for medium-voltage applications actuated by a bistable electromagnetic actuator for operating a pole part according to claim 8.

17. A circuit-breaker for medium-voltage applications actuated by a bistable electromagnetic actuator for operating a pole part according to claim 9.

18. A circuit-breaker for medium-voltage applications actuated by a bistable electromagnetic actuator for operating a pole part according to claim 10.
